(19) United States
(12) Patent Application Publication
(10) Pub. No.: US 2025/0145207 A1
(43) Pub. Date: May 8, 2025

(54) All Terrain Wagon-Ski

(71) Applicant: Eric Curtis, 2793, AL (US)

(72) Inventor: Eric Curtis, 2793, AL (US)

(21) Appl. No.: 18/387,824

(22) Filed: Nov. 7, 2023

(51) Int. Cl. B62B 13/18; B62B 3/00; B62B 5/06

(52) U.S. Cl. CPC B62B 13/18; B62B 3/002; B62B 5/067; B62B 2206/006; B62B 2301/05

(57) ABSTRACT

A convertible carriage for transporting subjects on a plurality of operating surfaces. The convertible carriage includes a receptacle, a sledge attached to the receptacle, a set of wheel assemblies, and a set of telescopic landing gears attached to the receptacle, and connected to the wheel assemblies. The telescopic landing gears are configured to operably extend or retract to switch the convertible carriage between a rolling operation mode and a sliding operation mode. In the rolling operation mode, one or more wheel assemblies from the set of wheel assemblies are in contact with the operating surface such that the convertible carriage is transportable on an operating surface by rolling of the wheel assemblies. In the sliding operation mode, the set of wheel assemblies are retracted to allow the sledge to contact with the operating surface such that the convertible carriage may be transportable on the operating surface by sliding.

### FIELD OF THE INVENTION

The disclosure relates generally to carriages used for transportation. Particularly and not exclusively, the subject matter of the instant disclosure relates to the construction and configuration of a convertible carriage for transporting subjects, such as cargo, equipment, pets, persons, plants, and the like, on a plurality of operating surfaces.

### BACKGROUND

Wheeled wagons or carriages have been the preferred mode of transporting subjects, such as cargo, equipment, pets, persons, plants, and the like. Wheels reduce effort required for moving the convertible carriages, by decreasing friction, and providing leverage for transferring force efficiently.

However, wheeled carriages are unsuitable for rough, uneven, or soft operating surfaces. For instance, wheeled carriages are unsuitable for use in rocky terrains, gravel or dirt roads, or on operating surfaces with sand or snow, where the wheels are likely to get stuck or prevented from moving by obstacles on the operating surface. Further, in some applications, wheeled carriages are inconvenient to use due to the wheels' large footprint.

On the other hand, sledges facilitate efficient travel on uneven or soft operating surfaces, and with appropriate runners or sliders, can prove to be efficient over a wider range of operating surfaces compared to wheeled carriages. However, sledges fall short in applications requiring transportation over relatively smooth and level operating surfaces, as they add friction while being dragged on flat operating surfaces.

While each of the above modes of transportation has its advantages in different situations, neither offer adequate solutions for many applications where subjects have to be transported across a plurality of operating surfaces. For instance, while skiing equipment can be carried in a sledge through the snow, a different mode of transportation would be necessary to transport the skiing equipment inside a building. In such instances, a user may be required to move the skiing equipment from the sledge to a wheeled carriage, thereby adding effort and time, and causing inconvenience to the user.

While some solutions have been offered to solve the above problems, these typically involve complicated mechanical structures, increasing cost, weight, or reducing the durability of the product as a whole. Such solutions are also do not provide mechanisms for quick and convenient switching between the modes of transportation.

Therefore, there is a need in the art for a convertible carriage that is easily adaptable to a plurality of operating surfaces.

### SUMMARY

In order to obviate the shortcomings of the background art, a convertible carriage is provided and illustrated in the instant disclosure.

Principally, in accordance with the most preferred embodiment of the present disclosure, a convertible carriage for transporting subjects on a plurality of operating surfaces may include a receptacle, a sledge attached to the receptacle, a set of wheel assemblies, and a set of telescopic landing gears attached to the receptacle, and connected to the set of wheel assemblies. The set of telescopic landing gears is configured to operably extend or retract to switch an operation mode of the convertible carriage between a rolling operation mode and a sliding operation mode. In the rolling operation mode, one or more wheel assemblies from the set of wheel assemblies are in contact with the operating surface such that the convertible carriage may be transportable on an operating surface by rolling of the one or more wheel assemblies. In the sliding operation mode, the one or more wheel assemblies are retracted to allow the sledge to come into contact with the operating surface such that the convertible carriage may be transportable on the operating surface by sliding.

In some embodiments, each wheel assembly from the set of wheel assemblies may be connected to a distal end of a corresponding telescopic landing gear from the set of telescopic landing gear. When the corresponding telescopic landing gear may be extended to switch the operation mode of the convertible carriage to the rolling operation mode, the one or more wheel assemblies extend and come into contact with the operating surface. When the corresponding telescopic landing gear may be retracted to switch the operation mode of the convertible carriage to the sliding operation mode, the one or more wheel assemblies retract to allow the sledge to come into contact with the operating surface.

In some embodiments, each wheel assembly from the set of wheel assemblies may be configured to the corresponding telescopic landing gear through a set of foldable links. When the corresponding telescopic landing gear may be extended to switch the operation mode of the convertible carriage to the sliding operation mode, the one or more wheel assemblies are retracted by the set of foldable links and cause the sledge to come in contact with the operating surface. When the corresponding telescopic landing gear may be retracted to switch the operation mode of the convertible carriage to the rolling operation mode, the one or more wheel assemblies are extended by the set of foldable links and come in contact with the operating surface.

In some embodiments, the receptacle may include a set of frames that provide structural support to the receptacle.

In some embodiments, the set of wheel assemblies are rotatable in any direction along a horizontal plane that may be parallel to the operating surface.

In some embodiments, the telescopic landing gear may be a linear actuator having an operably extendable and retractable arm.

In some embodiments, the linear actuator may be configured to be actuated by any one or combination of, a hydraulic means, a pneumatic means, an electrical means, and a manual actuation means.

In some embodiments, the linear actuator may be connected to the set of wheel assemblies by a set of foldable links such that when the linear actuator extends the arm, the set of wheel assemblies are retracted into the receptacle.

In some embodiments, the telescopic landing gear may include an outer shaft that encases an inner shaft. The inner shaft may be biased to extend outwards from one end of the outer shaft by a biasing means.

In some embodiments, the outer shaft may include a plurality of holes, and wherein the inner shaft may include a spring-actuated pin affixed thereto, the spring-actuated pin being configured to interface with any one of the plurality of holes on the outer shaft.

In some embodiments, at least one portion of the sledge has any one of, a planar surface, a convex surface, and a concave surface.

In some embodiments, the sledge may include a plurality of runners.

In some embodiments, the set of wheel assemblies are configured to be retractable into the receptacle through one or more provisions therefor on the sledge.

In some embodiments, the convertible carriage may include a handle attached to the receptacle. The handle may be attached to the receptacle through an extendable rod.

In some embodiments, the convertible carriage may include a braking means having a braking surface that may be operably configured to engage with and impede motion of the set of wheel assemblies.

In another aspect, a convertible carriage for transporting subjects on a plurality of operating surfaces may include a receptacle, a sledge, a set of wheel assemblies attached to the receptacle, and a set of telescopic landing gears attached to the receptacle, and connected to the sledge. The set of telescopic landing gears is configured to operably extend or retract to switch an operation mode of the convertible carriage between a rolling operation mode and a sliding operation mode. In the rolling operation mode, the sledge may be retracted to allow one or more wheel assemblies from the set of wheel assemblies to come into contact with the operating surface such that the convertible carriage may be transportable on an operating surface by rolling of the one or more wheel assemblies. In the sliding operation mode, the sledge is in contact with the operating surface such that the convertible carriage may be transportable on the operating surface by sliding.

In some embodiments, the sledge may be configured to a distal end of a corresponding telescopic landing gear from the set of telescopic landing gears. When the corresponding telescopic landing gear may be extended to switch the operation mode the convertible carriage to the sliding operation mode, the sledge extends to come into contact with the operating surface. When the corresponding telescopic landing gear may be retracted to switch the operation mode the convertible carriage to the rolling operation mode, the sledge retracts to allow the one or more wheel assemblies to come in contact with the operating surface.

In some embodiments, the sledge may be connected to the corresponding telescopic landing gear through a set of foldable links. When the corresponding telescopic landing gear may be extended to switch the operation mode the convertible carriage to the rolling operation mode, the sledge may be retracted by the set of foldable links and allows the one or more wheels assemblies to come into contact with the operating surface. When the corresponding telescopic landing gear may be retracted to switch the operation mode the convertible carriage to the sliding operation mode, the sledge may be extended by the set of foldable links and comes into contact with the operating surface.

In yet another aspect, a convertible carriage for transporting subjects on a plurality of operating surfaces may include a receptacle, a sledge attached to the receptacle, and a set of wheel assemblies retractably connected to the sledge by an actuation means, the actuation means configured to switch an operation mode of the convertible carriage between a rolling operation mode and a sliding operation mode. In the rolling operation mode, one or more wheel assemblies from the set of wheel assemblies are in contact with an operating surface. In the sliding operation mode, the set of wheel assemblies are retracted into the sledge to allow the sledge to come into contact with the operating surface.

The following description is illustrative in nature and is not intended to be in any way limiting. In addition to the aforementioned illustrative aspects, embodiments, and features of the present disclosure, further aspects, embodiments and features will become apparent by reference to the following detailed description.

### BRIEF DESCRIPTION OF THE ACCOMPANYING DRAWINGS

The accompanying drawings illustrate the best mode for carrying out the disclosure as instantly contemplated and set forth hereinafter. The instant disclosure may be more clearly understood from a consideration of the following detailed description of the preferred embodiments taken in conjunction with the accompanying drawings where all figures are diagrammatic and not to scale. Further, like reference letters and numerals indicate the corresponding parts in various figures in the accompanying drawings.

FIG. 1A illustrates an exemplary isometric view of a convertible carriage, according to embodiments of present disclosure.

FIGS. 1B and 1C illustrate exemplary side views of the convertible carriage in a rolling operation mode and a sliding operation mode respectively, according to embodiments of present disclosure.

FIGS. 2A and 2B illustrate exemplary front views of the convertible carriage in the rolling operation mode and the sliding operation mode respectively when a set of wheel assemblies thereof are configured outside a receptacle, according to embodiments of present disclosure.

FIGS. 3A and 3B illustrate exemplary front views of the convertible carriage in the rolling operation mode and the sliding operation mode respectively when the set of wheel assemblies are configured to be retractable into the receptacle, according to embodiments of present disclosure.

FIGS. 4A-4D illustrate exemplary front views of the convertible carriage where a telescopic landing gear is configured to a set of wheel assemblies, according to embodiments of present disclosure.

FIGS. 5A and B illustrate exemplary front views of the convertible carriage where the telescopic landing gear is configured to a sledge, according to embodiments of present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the invention as set forth.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “some embodiments” or “other embodiments” or “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, “substantially” means largely or considerably, but not necessarily wholly, or sufficiently to work for the intended purpose. The term “substantially” thus allows for minor, insignificant variations from an absolute or perfect state, dimension, measurement, result, or the like as would be expected by a person of ordinary skill in the art, but that do not appreciably affect overall performance.

As used herein, “about” means approximately or nearly, and in the context of a numerical value or range set forth means ±10% of the numeric value.

Throughout the present disclosure, “attachment means” include, but not be limited to, screws, nails, rivets, adhesives, magnets, hook and loop fasteners, hook and slot fasteners, interlocking elements, friction-grip releasable fasteners, fastening straps, and the like.

Existing carriages are not suitable for use over a plurality of operating surfaces. Often, an operating surface may have any one or combination of smooth, uneven and soft portions, leaving the user with the cumbersome task of choosing the best carriage for the specific task at hand. Existing carriages such as wheeled carriages are limited because they are not suitable for dragging through sand or snow, whereas a sledge will prove unsatisfactory when rolling is more convenient or required on some operating surfaces, such as on roads or concrete. Existing solutions for switching between wheel assemblies and sledges are cumbersome, use complicated mechanisms, and add weight to the convertible carriage.

Accordingly, in order to overcome at least the above-mentioned drawbacks associated with the existing carriages, the present disclosure proposes a convertible carriage with retractable wheel assemblies and/or sledges configured to enable convenient, quick, and efficient switching between modes of carriage, that may be suitable for use on a plurality of operating surfaces.

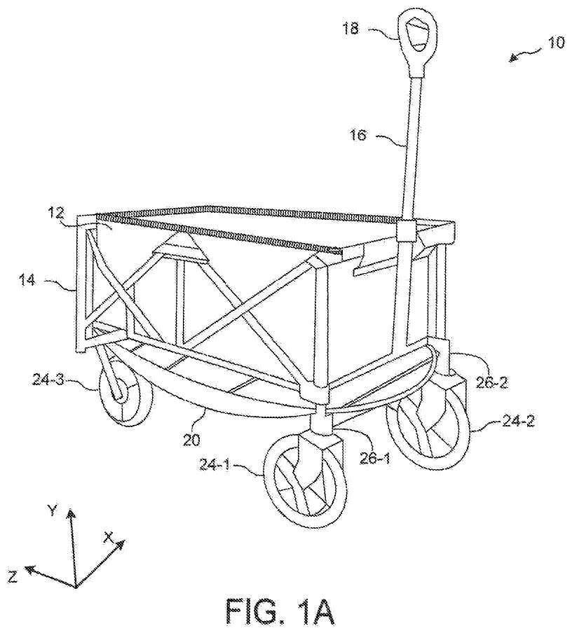

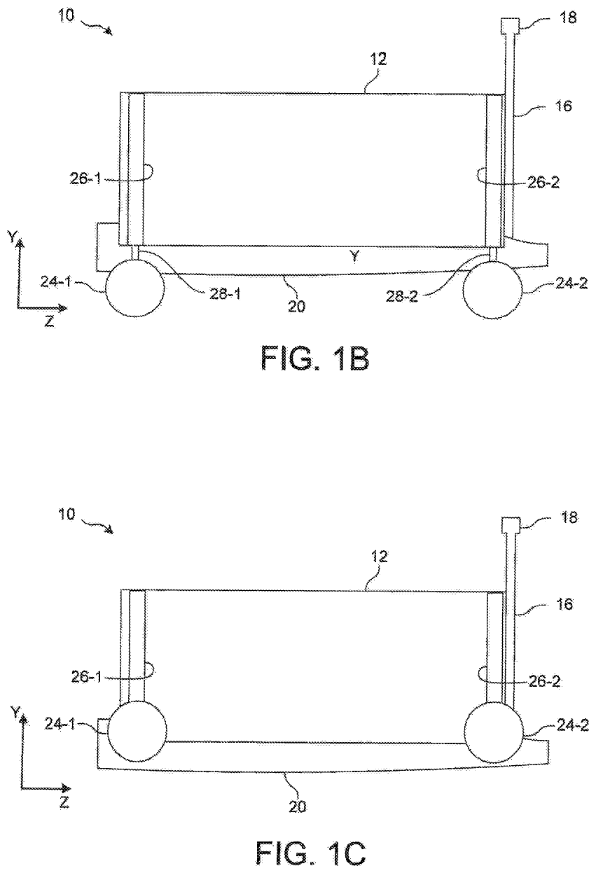

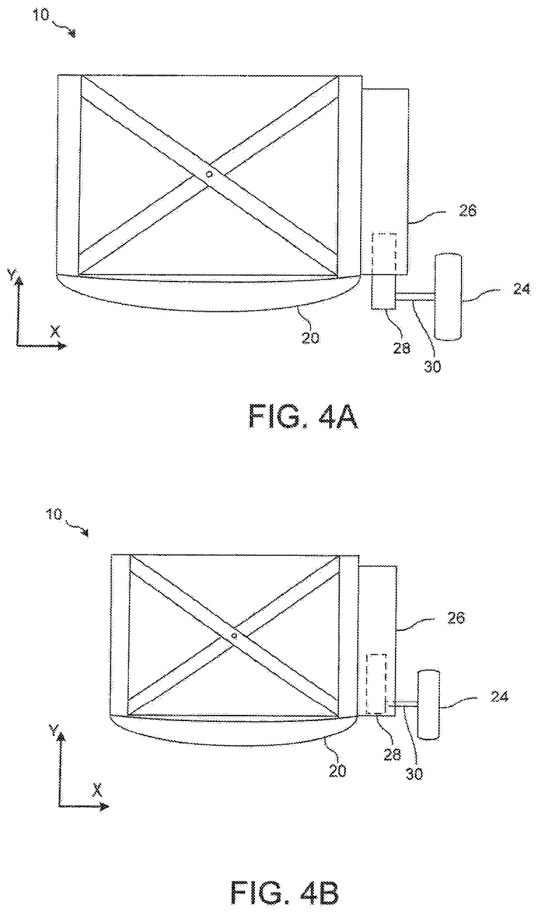

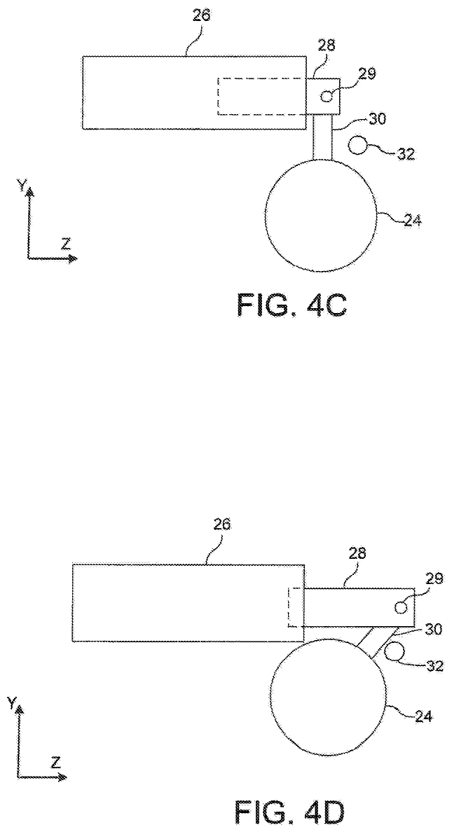

FIG. 1A illustrates an exemplary isometric view of a convertible carriage 10. As shown, the convertible carriage 10 includes a receptacle 12 having a set of frames 14, a handle 18 attached to the receptacle 12 through an extendable rod 16, a sledge 20 and a set of wheel assemblies, such as wheel assemblies 24-1, 24-2 and 24-3 (collectively referred to as the wheel assemblies 24). The convertible carriage 10 further includes a set of telescopic landing gears, such as telescopic landing gears 26-1 and 26-2 (collectively referred to as the telescopic landing gears 26), with each telescopic landing gear 26 having an extendable arm 28, as shown in FIGS. 1B, and 4A to 4D.

The convertible carriage 10 may allow one or more subjects/objects of transportation to be moved on a plurality of operating surfaces. In some embodiments, the subjects of transportation may be placed inside the receptacle 12. In some embodiments, the subjects may include, but not limited to, cargo, equipment, pets, persons, plants, food items, luggage, and the like. In some embodiments, the plurality of operating surfaces may include flat operating surfaces, uneven operating surfaces or soft operating surfaces. Flat operating surfaces may include, but not be limited to, roads, floors of buildings, concrete, or otherwise operating surfaces with a smooth contour. Uneven operating surfaces may include, but not be limited to, rocky terrains, mud roads, sand beaches, graveled or stoned roads, and the like. Soft operating surfaces may include, but not be limited to, operating surfaces with sand, dirt, ice, snow, grass, and the like. An operation mode of the convertible carriage 10 may be switched between a rolling operation mode and a sliding operation mode to allow the convertible carriage 10 to be moved in flat, uneven, and/or soft operating surfaces, as described below.

In some embodiments, the receptacle 12 may be made of flexible materials. In some embodiments, the receptacle 12 may be made of any one or combination of including, but not limited to, cloth, woven nylon, plastic, metal meshes, and the like. In other embodiments, the receptacle 12 may be made of rigid materials. In some embodiments, the receptacle 12 may be indicative of including, but not limited to, bags, baskets, boxes, containers, and the like. In some embodiments, the receptacle 12 may include a closeable flap that optionally restricts access to the subjects placed inside the receptacle 12. In some embodiments, the receptacle 12 may include books, loops, pockets, compartments, straps, and the like, for securely holding the subjects therein.

In some embodiments, the receptacle 12 may include the set of frames 14 configured to structurally support (and to retain) the shape and contours of the receptacle 12. The frames 14 may be made of materials including, but not limited to, plastic, wood, carbon or glass fiber, steel, aluminum, and the like.

In some embodiments, frames 14 may be detachable, and collapsible based on requirement. In some embodiments, the frames 14 may be made of one or more interconnected structures. In some embodiments, at least one of the interconnected structures may be integrally connected to the each other. In other embodiments, at least one of the interconnected structures may be pivotably connected to/with each other. In some embodiments, the interconnected structures may be foldable/collapsible to allow for compact packaging of the receptacle 12 when not in use.

In some embodiments, the dimensions and shape of the receptacle 12 may be altered based on inclusion or exclusion of one or more of the interconnected structures from the frame 14. In some embodiments, one or more of the interconnected structures may be configured to extend from the receptacle 12 such that one or more of the subjects may be removed from the receptacle 12 and placed on the extended interconnected structures for use as a table or a stand.

In other embodiments, the frames 14 may be indicative of support sheets made of rigid materials that provide structural support to the receptacle 12. The support sheets may be integrally configured into the receptacle 12. In some embodiments, the support sheets may be stitched into the receptacle 12 such that the receptacle 12 maintains the intended shape thereof.

In some embodiments, the wheel assemblies 24 may allow the convertible carriage 10 to be moved. The wheel assemblies 24 may reduce effort required to move the convertible carriage 10 by providing leverage and decreasing friction between the convertible carriage 10 and the operating surface beneath. The wheel assemblies 24 may be indicative of a rollable element that engages with and rolls over the operating surface. In some embodiments, the wheel assemblies 24 may be made of materials including, but not limited to, rubber, plastic, metal alloys, wood or other materials with suitable strength, durability, and weight. In some embodiments, the wheel assemblies 24 may be detachable from the convertible carriage 10. In other embodiments, the wheel assemblies 24 may be retractable and extendable based on requirements.

In some embodiments, each of the wheel assemblies 24 may include an axle connected to a rolling element. In some embodiments, the axle may include a bearing on a first end thereof. The rolling element may be connected to the axle through the bearing, such that the rolling element rotates freely on the axle. In some embodiments, the rolling element may have a substantially annular shape with the axle being fitted into a cavity of the annular rolling element. In some embodiments, the rolling element may have a substantially circular contour, or a contour indicative of a reuleaux polygon. The second end of the axle may be configured either to the receptacle 12, the frame 14 of the receptacle 12, the sledge 20, or the telescopic landing gear 26, as discussed subsequently in the present disclosure. The rolling element may be caused to come into contact with the operating surface when the convertible carriage 10 is in the rolling operation mode. The rolling element may allow the convertible carriage 10 to be transported by rolling on the operating surface.

In some embodiments, the wheel assemblies 24 may allow the convertible carriage 10 to be rolled in at least one direction. In such embodiments, the wheel assemblies 24 may be rotated along a first axis that is substantially parallel to the operating surface. In an example, the rolling elements of the wheel assemblies 24 may rotate along the axle. The first axis may be indicative of the ‘X’ axis as shown in FIGS. 1A to 5B. In such embodiments, the wheel assemblies 24 may allow the convertible carriage 10 to be moved in the direction in which the wheel assemblies 24 are aligned. In such embodiments, to change the direction of movement of the convertible carriage 10, the convertible carriage 10 may be lifted and oriented such that the wheel assemblies 24 align in the direction in which the convertible carriage 10 is intended to be moved.

In other embodiments, the wheel assemblies 24 may be omnidirectionally rotatable. In such embodiments, the wheel assemblies 24 may rotate along the first axis to allow the receptacle 12 to be moved. In embodiments where the wheel assemblies are omnidirectionally rotatable, the wheel assemblies 24 may also be rotatable along a second axis, thereby allowing the convertible carriage 10 to be moved in any direction on a horizontal plane formed by the first and a third axes. The second and third axis may be indicative of the ‘Y’ axis and ‘Z’ respectively, as shown in FIGS. 1A to 5B, and the horizontal plane may be indicative of the plane formed by the X and Z axes. In such embodiments, the wheel assemblies 24 may be self-aligning. The wheel assemblies 24 may be configured to align themselves to move in any direction in which a force is applied to the convertible carriage 10. In an example, the wheel assemblies 24 may be aligned in a first direction. When a force is applied to the convertible carriage 10 in a second direction, which may not be collinear to the first direction, the wheel assemblies 24 may rotate along the Y axis and align themselves to allow the convertible carriage 10 to be moved in the second direction. Thereafter, in such examples, the wheel assemblies 24 may rotate about the X axis to move the convertible carriage 10 in the second direction.

In such embodiments, the rolling elements of the wheel assemblies 24 may be any one of including, but not limited to, castor wheels, mecanum wheels, poly wheels, ball transfer units, and the like.

In some embodiments, the rolling elements of the wheel assemblies 24 may include any one or combination of including, but not limited to, grooves, ridges, spikes, bars, cleats, and the like, on a circumferential surface thereof, to allow the wheel 24 to the operating surface while moving through the operating surface, for example, through soft operating surfaces such as sand, ice or snow. In some embodiments, the circumferential surface of the wheel assemblies 24 may be suitably adapted to maximize friction between the wheel assemblies 24 and the operating surface.

In some embodiments, the wheel assemblies 24 may be attached to the telescopic landing gear 26. In such embodiments, the wheel assemblies 24 may be extended or retracted by the telescopic landing gear 26. In other embodiments, the wheel assemblies 24 may be attached to the receptacle 12. In some embodiments, the wheel assemblies 24 may be attached to the frame 14 of the receptacle 12. In some embodiments, the wheel assemblies 24 may be attached to the telescopic landing gear 26, or the receptacle 12 or the frame 14 thereof through any one of the attachment means.

In some embodiments, one or more of the wheel assemblies 24 may be caused to come in contact with the operating surface when the convertible carriage 10 is in the rolling operation mode. In some embodiments, a subset of the wheels assemblies 24 may be in contact with the operating surface and support the weight of the convertible carriage 10, and another subset of the wheel assemblies 24 may be elevated from the operating surface. The subset of wheel assemblies 24 may be one or more, or all the wheel assemblies in the set of wheels assemblies 24. In embodiments where the wheel assemblies 24 is attached to the receptacle 12, one or more of the wheel assemblies 24 may be caused to come in contact with the operating surface when the sledge 20 is retracted by the telescopic landing gear 26. In embodiments where the wheel assemblies 24 is attached to the telescopic landing gear 26, one or more of the wheel assemblies 24 may come in contact with the operating surface when the wheel assemblies 24 are extended. When one or more of the wheel assemblies 24 is caused to come in contact with the operating surface, the wheel assemblies 24 may support the weight of the receptacle 12, and in turn the convertible carriage 10, thereby allowing the convertible carriage 10 to be rolled on flat operating surfaces. When in the sliding operation mode, one or more of the wheel assemblies 24 may be elevated from the operating surface, thereby allowing the sledge 20 to come into contact with the operating surface.

In some embodiments, the sledge 20 may be configured to operably support the weight of the receptacle 12. The sledge 20 may include an upper surface and a lower surface. In embodiments where the sledge 20 is attached to receptacle 12, the upper surface may be in contact with the receptacle 12. In such embodiments, the upper surface of the sledge 20 may form the base of the receptacle 12. In some embodiments, the lower surface of the receptacle 12 may be configured to be retractably in contact with the operating surface. In some embodiments, the lower surface of the sledge 20 may be configured to allow the convertible carriage 10 to be dragged over the operating surface. In some embodiments, the lower surface of the sledge 20 may have a substantially planar surface and be maintained in a substantially horizontal/parallel orientation with respect to the surface. In some embodiments, the lower surface the sledge 20 may have a substantially convex surface. In yet other embodiments, the lower surface of the sledge 20 may have a substantially concave surface. In some embodiments, the sledge 20 may be used to drag the convertible carriage 10 on uneven or soft operating surfaces.

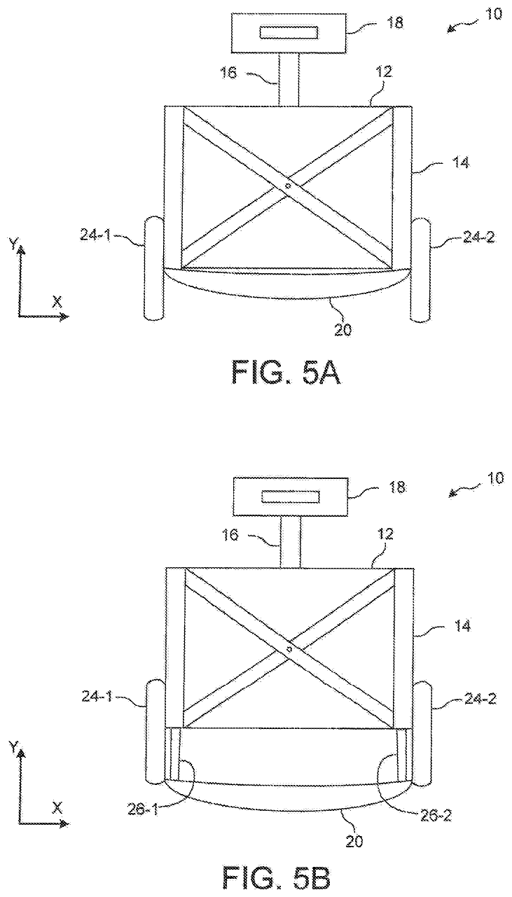

In some embodiments, the sledge 20 may be attached to the receptacle 12. In some embodiments, the sledge 20 may be attached to the frame 14 of the receptacle 12, as shown in FIGS. 5A and 5B. In other embodiments, the sledge 20 may be attached to telescopic landing gear 26. In such embodiments, the sledge 20 may be extended or retracted by the telescopic landing gear 26. In some embodiments, the sledge 20 may be attached to the receptacle 12 or the frame 14 thereof, or the telescopic landing gear 26 using any one of the attachment means.

The lower surface of the sledge 20 may be allowed to come in contact with the operating surface when the convertible carriage 10 is in the sliding operation mode. In embodiments where the sledge 20 is attached to the receptacle 12, the lower portion of the sledge 20 may be caused to come in contact with the operating surface when the wheel assemblies 24 are retracted by the telescopic landing gear 26. In embodiments where the sledge 20 is attached to the telescopic landing gear 26, the lower surface of the sledge 20 may come in contact with the operating surface when the sledge 20 is extended. When the lower portion of the sledge 20 is caused to come in contact with the operating surface, the sledge 20 may support the weight of the receptacle 12, and in turn the convertible carriage 10, thereby allowing the convertible carriage 10 to be moved/dragged on uneven and soft operating surfaces. When in the rolling operation mode, the sledge 20 may be elevated from the operating surface.

In some embodiments, the sledge 20 may be made of any one or combination of including, but not limited to, wood, metal, carbon or glass fibers, plastic composites, and the like. In some embodiments, the sledge 20 may be made of buoyant materials. In some embodiments, the sledge 20 may be contoured to minimize contact with the operating surface. In other embodiments, the sledge 20 may be contoured or textured to minimize friction with the operating surface. In some embodiments, the sledge 20 may include a coating that reduces friction between the sledge 20 and the operating surface. The coating may be indicative of, for example, a low-friction material, a lubricant coating, and the like.

In some embodiments, the sledge 20 may include a plurality of runners removably attached thereto. The plurality of runners may allow the sledge 20 to smoothly drag through soft operating surfaces. In some embodiments, the plurality of runners may be configured to provide ground clearance to the receptacle 12 during transportation. In some embodiments, the plurality of runners may be detachably configured to the sledge 20, based on requirements. In some embodiments, the plurality of runners may be detachably configured to the receptacle 12 or the wheel assemblies 24.

In some embodiments, each wheel assembly 24 may be configured to a corresponding telescopic landing gear from the set of telescopic landing gears 26, as shown subsequently in FIGS. 1B, 1C, and 4A to SC. In some embodiments, each of the telescopic landing gears 26 may include an extendable arm 28, as shown subsequently in FIGS. 1B, 1C, and 4A to SC. The extendable arm 28 may be operably, and reversibly, extended or retracted from the telescopic landing gears 26 such that the weight of the receptacle 12 may be supportable either by the wheel assemblies 24 or the sledge 20 based on whether the telescopic landing gear 26 is extended or retracted. In some embodiments, the extendable arm 28 may include a distal end that interfaces/connects with the wheel assemblies 24. In other embodiments, the distal end of the extendable arm 28 interfaces with the sledge 20, as shown in FIGS. 5A and 5B.

The telescopic landing gear 26 may be configured to switch an operation mode of the convertible carriage 10 between a rolling operation mode and a sliding operation mode. In the rolling operation mode, the wheel assemblies 24 may be in contact with the operating surface such that the convertible carriage 10 may be transportable on an operating surface by rolling of one or more of the wheel assemblies 24. In such embodiments, the weight of the convertible carriage 10 may be supported by one or more of the wheel assemblies 24, thereby allowing the convertible carriage 10 to be rolled, such as over flat operating surfaces. In such embodiments, the sledge 20 is in a retracted position and doesn't come in contact with the flat operating surface in the rolling mode of operation.

In the sliding operation mode, the wheel assemblies may be retracted to allow the sledge 20 to come into contact with the operating surface such that the convertible carriage 10 may be transportable on the operating surface by sliding. In such embodiments, the weight of the convertible carriage 10 may be supported by the sledge 20, thereby allowing the convertible carriage 10 to slide be dragged over the operating surface, such as over soft or uneven operating surfaces. Depending on the orientation or the operation mode of the telescopic landing gear 26, one or more of the wheel assemblies 24 or the sledge 20 may be extended or retracted, and caused to come in contact therewith with the operating surface based on the type of operating surface over which the convertible carriage 10 is to be transported.

In some embodiments, the handle 18 may be connected to the receptacle 12 through the extendable rod 16. In other embodiments, the handle 18 may be an integral part of the receptacle 12. In yet other embodiments, the handle 18 may be absent and the convertible carriage 10 may be towed or dragged using the extendable rod 16. In some embodiments, the handle 18 may have a gripping surface that may be gripped by a user for transportation. In some embodiments, the extendable rod 16 may be pivotably connected to the receptacle 12 such that the length of the handle 18 may be adjusted suitably to facilitate ease of use by users of different heights. In some embodiments, the extendable rod 16 may be configured to the receptacle 12 by the frames 14 thereof. In such embodiments, the frame 14 may have at least one hollow shaft connected to the interconnected structures of the frame 14, to accommodate the extendable rod 16. In such embodiments, the extendable rod 16 may be configured to slide into the hollow shaft when retracted. The extendable rod 16 may be pulled out from the hollow shaft to a desired length and locked in place. In other embodiments, the extendable rod 16 may be pivotably connected to the frame 14. In some embodiments, the extendable rod 16 may be attached to the frame 14 using any one of the attachment means.

In some embodiments, the convertible carriage 10 may be pulled one or more domesticated animals such as dogs, horses, and the like, or by a motorized vehicle. In some embodiments, the handle 18 may be attached to any one of a rope, a chain, a bar or a lift, but not limited thereto, that is in turn hooked or connected to a vehicle, a pulley, or a similar carrying mode for a “tow” mode of operation. In other embodiments, the wheel assemblies 24 may be motorized to allow the wheel assemblies 24 to be operably propelled on the operating surface.

FIGS. 1B and 1C illustrate exemplary side views of the convertible carriage 10 in the rolling operation mode and the sliding operation mode respectively, according to embodiments of present disclosure. As shown, the wheel assemblies 24-1, 24-2 may be configured to respective telescopic landing gears 26-1, 26-2. The telescopic landing gears 26-1, 26-2 may have respective extendable arms 28-1, 28-2.

In some embodiments, the receptacle 12 may have any polyhedral geometric profile formed by a plurality of polygonal surfaces. At least one of the polygonal surfaces may correspond to the bottom (hereinafter referred to as the bottom face) of the receptacle 12. One or more lateral surfaces of the receptacle 12 may extend upwards from each edge of the bottom face. In some embodiments, the corresponding axles of the wheel assemblies 24 may be configured to the lateral surfaces of the receptacle 12 such that the convertible carriage 10 is moveable in at least one direction along the axis of the axle. In such embodiments, each of the wheel assemblies 24 may be attached to any two or more of the lateral surfaces of the receptacle 12 that are substantially parallel to each other. In the aforementioned embodiments, the axle may have a substantially straight geometric profile, such that the axle may be substantially parallel to the operating surface. In other embodiments, the axles of the wheel assemblies 24 may have a substantially L-shaped geometric profile. In such embodiments, the axle may be attached to the bottom face of the receptacle 12 at the first end thereof, and attached to the rolling element at the second end thereof such that the rolling elements rotate on an axis that is substantially parallel to the operating surface.

In some embodiments, the wheel assemblies 24 may be attached to the telescopic landing gear 26. The axle of the wheel assemblies 24 may be affixed to the distal end of the extendable arm 28. In such embodiments, the telescopic landing gears 26 may be attached to the side faces of the receptacle 12. The orientation of the telescopic landing gears 26 may be suitably adapted to allow the rolling elements of each of the wheel assemblies 24 to rotate in the same direction.

In such embodiments, when the telescopic landing gears 26 are extended, the corresponding wheel assemblies 24 may come into contact with the operating surface, thereby supporting the weight of the receptacle 12. Further, in such embodiments, when the telescopic landing gears 26 are retracted, the sledge 20 may come into contact with the operating surface, thereby supporting the weight of the receptacle 12.

In other embodiments, the axles of the wheel assemblies 24 may be configured to the frame 14 of the receptacle 12. The wheel assemblies 24 may be configured such that the rolling elements thereof move in substantially the same direction.

In some embodiments, the wheel assemblies 24 in the rolling operation mode and the sledge 20 in the sliding operation mode may be configured to operate in a manner that maintains the receptacle 12 in a substantially horizontal orientation with respect to the operating surface, Maintaining the receptacle 12 in a substantially horizontal orientation may be critical while transporting subjects that may be susceptible to falling or spilling out of the receptacle 12, such as liquids.

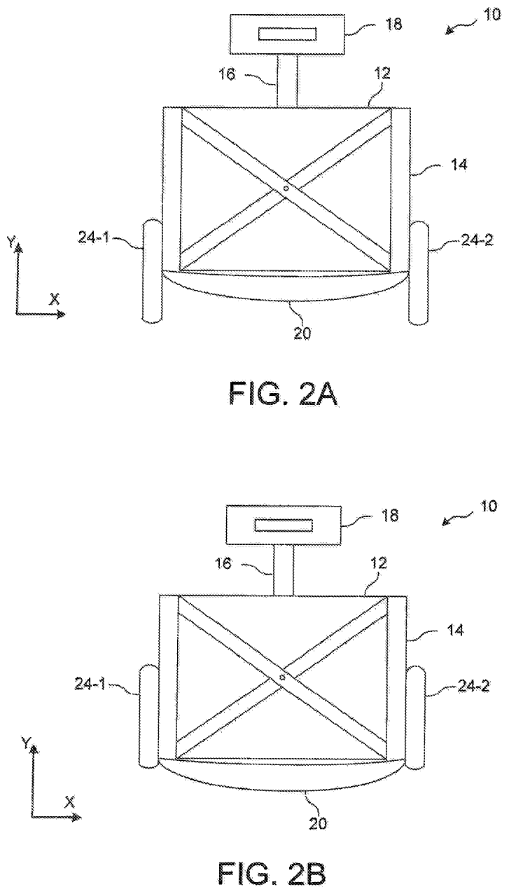

FIGS. 2A and 2B illustrate exemplary front views of the convertible carriage 10 in the rolling operation mode and the sliding operation mode respectively when the wheel assemblies 24 are configured outside the receptacle 12, according to embodiments of present disclosure. As shown, the wheel assemblies 24 may be configured on the sides of the receptacle 12. In some embodiments, the telescopic landing gears 26 may be integrated into the frames 14. In such embodiments, the telescopic landing gear 26 may be operable through the frames 14.

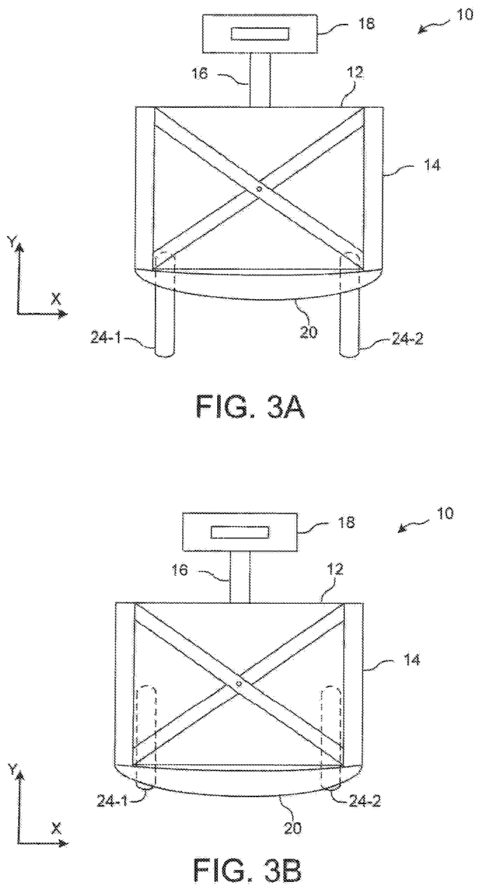

FIGS. 3A and 3B illustrate exemplary front views of the convertible carriage 10 in the rolling operation mode and the sliding operation mode respectively when the wheel assemblies 24 are configured to be retractable into the receptacle 12, according to embodiments of present disclosure. As shown, the wheel assemblies 24 may be configured to be retracted into the receptacle 12. In such embodiments, the sledge 20 may have one or more provisions that allow the wheel assemblies 24 to be passed therethrough during retraction and extension, thereby providing for a compact design. In such embodiments, portions of the receptacle 12 may be used for storing the wheel assemblies 24 when retracted.

In some embodiments, one or more of, but not all, the wheel assemblies 24 may be retracted into the receptacle 12. In an example, a first and a second wheel assemblies at the front of the convertible carriage 10 may be retracted into the receptacle 12 while a third and a fourth wheel assemblies may be extended, and thereby continue to support the weight of the convertible carriage 10. In such embodiments, the convertible carriage 10 may be used as a wheelbarrow.

FIGS. 4A-4D illustrate exemplary front views of the convertible carriage 10 where the telescopic landing gear 26 is configured to the wheel assemblies 24, according to embodiments of present disclosure. As shown, the telescopic landing gears 26 may be connected to the corresponding wheel assemblies 24 through a set of foldable links 30. While FIGS. 4A-4D show one foldable link 30, it may be appreciated by those skilled in the art that the telescopic landing gear 26 may be connected to the wheel assemblies 24 through more than one foldable link 30. The set of foldable links 30 may be configured such that when the set of telescopic landing gears 26 are retracted, the wheel assemblies 24 may support the weight of the receptacle, and when the telescopic landing gears 26 are extended, the sledge 20 may support the weight of the receptacle 12. In some embodiments, the set of foldable links 30 may be interconnected such that a single telescopic landing gear 26 may retract or extend one or more of the wheel assemblies 24. In such embodiments, the set of foldable links 30 corresponding to the wheel assemblies 24 may be configured to a single telescopic landing gear 26 for simultaneous extension and retraction of the wheel assemblies 24. In some embodiments, the set of foldable links 30 may be made of resilient or rigid materials for mechanical communication of force from the telescopic landing gears 26 to the corresponding wheel assemblies 24.

In some embodiments, the telescopic landing gear 26 may be a linear actuator having an operably extendable and retractable arm, such as the extendable arm 28. In some embodiments, the linear actuator may be actuatable by any one or combination of means including, but not limited to, a hydraulic means, a pneumatic means, an electrical means, and a manual actuation means. In such embodiments, corresponding hydraulic or pneumatic structures, or electrical elements such as electric switches, may be used for actuating the linear actuator. Further, in some embodiments, the extendible arm 28 may be actuatable by a manual actuation means, such as a lever or a handle that allow the extendable arm 28 of the telescopic landing gears 26 to be physically extended or retracted therefrom. Users of the convertible carriage 10 may use any one of the aforementioned means to operably extend or retract the telescopic landing gear 26.

In some embodiments, the telescopic landing gear 26 may include an outer shaft that encases an inner shaft. The inner shaft may be movably encased in the outer shaft. The inner shaft may be biased to extend outwards from one end of the outer shaft by a biasing means. In some embodiments, the biasing means may be any one or combination of including, but not limited to, mechanical pressure generated by springs, hydraulic or pneumatic pressure generated by the hydraulic or pneumatic means respectively, magnetic pressure generated by magnets, rotation of electric motors engaging with the inner shaft, and the like. The biasing means may be configured on a first end of the outer shaft such that the inner shaft is biased to be extended out from a second end thereof. In some embodiments, the biasing means may be operable by users of the convertible carriage 10 to selectively cause the biasing means to bias the inner shaft outwards from the outer shaft.

In some embodiments, the outer shaft may include a plurality of holes. The plurality of holes may be provided at a plurality of positions along the length of the outer shaft. In some embodiments, the inner shaft may include a spring-actuated pin affixed thereto. The spring-actuated pin may be configured to interface with any one of the plurality of holes on the outer shaft. In some embodiments, the inner shaft may be manually moved to a position such that the spring-actuated pins hold/lock the inner shaft at the desired level of extension with respect to the outer shaft, thereby allowing the height of the telescopic landing gear 26 to be adjusted. Such embodiments may also allow the convertible carriage 10 to be locked in either the rolling operation mode or the sliding operation mode, as desired. In an example, the height of the telescopic landing gear 26 may be suitably adjusted to correspondingly adjust the ground clearance of the convertible carriage 10.

In other embodiments, the telescopic landing gear 26 may be a pivotable actuator that pivots a pivotable arm associated therewith when actuated. In such embodiments, the wheel assemblies 24 may be configured to the distal end of the pivotable arm such that the wheel assemblies 24 may be retracted by pivoting them into the receptacle 12.

In some embodiments, the telescopic landing gear 26 may be connected to the wheel assemblies 24 by the extendable arm 28 such that the wheel assemblies 24 are correspondingly extended or retracted when the extendable arm 28 is extended or retracted. In other embodiments, the telescopic landing gear 26 may be connected to the wheel assemblies 24 through the set of foldable links 30. In such embodiments, the set of foldable links 30 may be configured such that the wheel assemblies 24 are extended or retracted when the extendable arm 28 is retracted or extended respectively. In some embodiments, the set of foldable links 30 may be configured to adapt the direction of movement of the wheel assemblies 24 in response to actuation of the telescopic landing gears 26 based on requirements. In some embodiments, the set of foldable links 30 may also be configured to suitably change the direction of retraction of the wheel assemblies 24 based on the interlocking configurations thereof.

FIGS. 4A and 4B show embodiments where the telescopic landing gear 26 may be configured to actuate the extendable arm 28 in a direction substantially perpendicular to the operating surface. In such embodiments, the extension and retraction of the extendable arm 28 may correspond to the extension and retraction of the wheel assemblies 24 respectively.

FIGS. 4C and 4D show embodiments where the set of links 30 may allow the wheel assemblies 24 to be pivotably retracted. In some embodiments, the telescopic landing gear 26 may be configured to actuate the extendable arm 28 in a direction substantially parallel to the operating surface. Further, in some embodiments, the set of foldable links 30 may be connected to the extendable arm 28 by a pivotable joint 29. In some embodiments, when the extendable arm 28 is extended, the wheel assemblies 24 may be caused to engage with an abutment 32 whereby the wheel assemblies 24 may be caused to pivot by the pivotable joint 29 and retract towards the receptacle 12. In some embodiments, the abutment 32 may extend from the frames 14, or the sledge 20. In some embodiments, the set of foldable links 30 and the abutment 32 may allow the wheel assemblies 24 to be pivoted in the plane corresponding to about the axis of rotation in which the wheel assemblies 24 roll. In other embodiments, the set of foldable links 30 and the abutments 32 may be configured to pivot the wheel assemblies 24 about an axis perpendicular to the direction in which the wheel assemblies 24 roll.

In some embodiments, the convertible carriage 10 may be prevented from moving by lowering the sledge 20 thereof to come in contact with the operating surface. In such embodiments, friction between the operating surface and the sledge 20 may prevent the convertible carriage 10 from moving, until a force greater than the friction therebetween is applied to the convertible carriage 10.

In other embodiments, the convertible carriage 10 may include having a braking surface that is operably configured to engage with and impede motion of the wheel assemblies 24 to prevent the wheel assemblies 24 from moving. In some embodiments, the braking means may be a friction braking assembly having the braking surface that may be operably caused to engage with the wheel assemblies 24. In such embodiments, the braking surface may bring the wheel assemblies 24 to a halt by applying friction thereto. In some embodiments, an engagement means, including but not limited to, pedals, levers, switches, or the like, may be hydraulically, pneumatically, or mechanically connected to the braking surface such that when the engagement means is actuated, the braking surface engages with the wheel assemblies 24. In some embodiments, the braking surface may engage with the rolling element of the wheel assemblies 24. In such embodiments, the braking means may prevent the convertible carriage 10 from moving, and securely keep the convertible carriage 10. In an example, when the convertible carriage 10 is in the rolling operation mode and is required to be securely halted on an operating surface having an uphill gradient, the braking means may prevent secure the wheel assemblies 24 from rotating, and thereby prevent the convertible carriage 10 from moving. In some embodiments, the braking surface may be indicative of a rod that passes through the rolling elements of the wheel assemblies 24 to lock rotation of the rolling elements.

FIGS. 5A and 5B illustrate exemplary front views of the convertible carriage 10 where the telescopic landing gear 26 is configured to the sledge 20, according to embodiments of present disclosure. In another aspect of the present disclosure illustrated in FIGS. 5A and 5B, the sledge 20 may be operably retractable. In such embodiments, the wheel assemblies 24 and the telescopic landing gear 26 may be attached to the receptacle 12. In such embodiments, the telescopic landing gear 26 may be connected to the sledge 20, and configured to extend or retract to switch the operation mode of the convertible carriage between the rolling operation mode and the sliding operation mode. In such embodiments, when in the rolling operation mode, the sledge 20 may be retracted to allow the wheel assemblies 10 to come into contact with the operating surface such that the convertible carriage 10 is transportable on an operating surface by rolling of the wheel assemblies 24. Further, in such embodiments, when in the sliding operation mode, the sledge is in contact with the operating surface such that the convertible carriage 10 may be transportable on the operating surface by sliding.

In some embodiments, the sledge 20 may be configured to the distal end of the extendable arm 28 of the telescopic landing gear 26 such that the extension and retraction of the extendable arm 28 may correspond to the retraction and extension of the sledge 20 respectively. In some embodiments, the sledge 20 may be configured to the extendable arm 28 through a set of foldable links. In such embodiments, the set of foldable links may be configured such that the sledge 20 may be retracted or extended when the extendable arm 28 is extended or retracted respectively. The sledge 20 may support the weight of the receptacle 12 the sledge 20 when extended. Conversely, in such embodiments, the wheel assemblies 24 may support the weight of the receptacle 12, and in turn the weight of the convertible carriage 10, when the sledge 20 is retracted.

In yet another aspect of the present disclosure, the wheel assemblies 24 may be retractably connected to the sledge 20. In such embodiments, the wheel assemblies 24 may be connected to the sledge 20 by an actuation means. In some embodiments, the actuation means may be indicative of including, but not limited to a spring, a resiliently elastic structure such as rubber, shock absorbers, suspension systems, and the like. In some embodiments, the actuation means may be indicative of the telescopic landing gears 26. In some embodiments, a first end of the actuation means may be connected to the wheel assemblies 24, and a second end of the actuation means may be connected to the sledge 20. In some embodiments, the first end of the actuation means may be connected to an axle of the wheel assemblies 24.

In some embodiments, the actuation means may be configured to switch the operation mode of the convertible carriage between the rolling mode and the sliding mode. In some embodiments, when in the rolling mode, the wheel assemblies 24 may be in contact with an operating surface. In some embodiments, when in the sliding mode, the wheel assemblies 24 may be retracted into the sledge 20 to allow the sledge 20 to come into contact with the operating surface.

In some embodiments, the actuation means may bias the wheel assemblies 24 to come in contact with the operating surface such that the convertible carriage 10 may be supported on the wheel assemblies 24, and rolled for transportation, such as on flat operating surfaces. When the wheel assemblies 24 encounter an uneven operating surface, such as a rock, the actuation means may cause the wheel assemblies 24 to be retracted into the sledge 20, thereby causing the sledge 20 to come in contact with the operating surface and support the weight of the convertible carriage 10. In an example, the actuation means indicative of the spring may be compressed by an obstacle, such as a rock, on the uneven operating surface, thereby retracting the wheel assemblies 24, when the effort required to roll over the obstacle is greater than the force exerted by the spring. In such examples, the wheel assemblies 24 may be extended when the convertible carriage 10 crosses the obstacle.

In some embodiments, the convertible carriage 10 may include a hybrid operation mode. In such embodiments, the sledge 20 and one or more wheel assemblies 24 of the set of wheels assemblies 24 may be caused to be in contact with the operating surface. In such embodiments, the sledge 20 and the wheel assemblies 24 may partially support the weight of the receptacle 12. In such embodiments, the wheel assemblies 24 may reduce friction experienced by the sledge 20, thereby extending the life span of the sledge 20.

In other embodiments, the operating surface may be indicative of including, but not limited to, water, marshes, graveled roads, wet sand, surface with reduced friction such as ice, wet flooring, or oiled flooring, and the like. In some embodiments, the sledge 20 may be made of substantially buoyant materials. In such embodiments, the sledge 20 may allow the convertible carriage 10 to float on water, or any other liquid or substantially wet operating surfaces. Further, in some embodiments, flaps, grooves, spikes or tread patterns on the rolling elements of the wheel assemblies 24 may allow adhere to such operating surfaces. Additionally, in some embodiments where the wheel assemblies 24 are motorized, the wheel assemblies 24 may allow the convertible carriage 10 to be propelled.

The present disclosure solves the problems of adaptability to changing operating surfaces associated with the prior art by providing a convertible carriage. The convertible carriage may be implemented to provide efficient carriage of one or more subjects on a plurality of operating surfaces. The convertible carriage may allow a user to conveniently switch the operating mode thereof by extending or retracting the telescopic landing gears. The telescopic landing gears, in turn, reversibly retract or extend the wheel assemblies and the sledge. By extending or retracting the extendable arms of the telescopic landing gears, the user may conveniently switch the operation mode of the convertible carriage from the rolling operation mode to the sliding operation mode, or vice versa, and adapt the convertible carriage to the changing operating surface. The convertible carriage may be easily and quickly converted into the appropriate operation mode, allowing the user to easily transport the subjects from a first operating surface, such as a beach with sand, to a second operating surface, such as a road, for example, without having to switch to another carriage.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

The skilled person will be aware of a range of possible modifications of the various embodiments described above. Accordingly, the present disclosure is defined by the claims and their equivalents.

What is claimed is:

1. A convertible carriage for transporting subjects on a plurality of operating surfaces, comprising:
a receptacle;
a sledge attached to the receptacle;
a set of wheel assemblies; and
a set of telescopic landing gears attached to the receptacle, and connected to the set of wheel assemblies, wherein the set of telescopic landing gears is configured to operably extend or retract to switch an operation mode of the convertible carriage between a rolling operation mode and a sliding operation mode, wherein in the rolling operation mode, one or more wheel assemblies from the set of wheel assemblies are in contact with the operating surface such that the convertible carriage is transportable on an operating surface by rolling of one or more wheel assemblies, and wherein in the sliding operation mode, the one or more wheel assemblies are retracted to allow the sledge to come into contact with the operating surface such that the convertible carriage is transportable on the operating surface by sliding.

2. The convertible carriage of claim 1, wherein each wheel assembly from the set of wheel assemblies is connected to a distal end of a corresponding telescopic landing gear from the set of telescopic landing gear, wherein when the corresponding telescopic landing gear is extended to switch the operation mode of the convertible carriage to the rolling operation mode, the one or more wheel assemblies extend and come into contact with the operating surface, and when the corresponding telescopic landing gear is retracted to switch the operation mode of the convertible carriage to the sliding operation mode, the one or more wheel assemblies retract to allow the sledge to come into contact with the operating surface.

3. The convertible carriage of claim 1, wherein each wheel assembly from the set of wheel assemblies is configured to the corresponding telescopic landing gear through a set of foldable links, wherein when the corresponding telescopic landing gear is extended to switch the operation mode of the convertible carriage to the sliding operation mode, the set of wheel assemblies are retracted by the set of foldable links and cause the sledge to come in contact with the operating surface, and when the corresponding telescopic landing gear is retracted to switch the operation mode of the convertible carriage to the rolling operation mode, the one or more wheel assemblies from the set of wheel assemblies are extended by the set of foldable links and come in contact with the operating surface.

4. The convertible carriage of claim 1, wherein the receptacle comprises a set of frames that provide structural support to the receptacle.

5. The convertible carriage of claim 1, wherein the set of wheel assemblies are rotatable in any direction along a horizontal plane that is parallel to the operating surface.

6. The convertible carriage of claim 1, wherein the telescopic landing gear is a linear actuator having an operably extendable and retractable arm.

7. The convertible carriage of claim 6, wherein the linear actuator is configured to be actuated by any one or combination of: a hydraulic means, a pneumatic means, an electrical means, and a manual actuation means.

8. The convertible carriage of claim 6, wherein the linear actuator is connected to the set of wheel assemblies by a set of foldable links such that when the linear actuator extends the arm, the set of wheel assemblies are retracted into the receptacle.

9. The convertible carriage of claim 1, wherein the telescopic landing gear comprises an outer shaft that encases an inner shaft, and wherein the inner shaft is biased to extend outwards from one end of the outer shaft by a biasing means.

10. The convertible carriage of claim 9, wherein the outer shaft comprises a plurality of holes, and wherein the inner shaft comprises a spring-actuated pin affixed thereto, the spring-actuated pin being configured to interface with any one of the plurality of holes on the outer shaft.

11. The convertible carriage of claim 1, wherein at least one portion of the sledge has any one of: a planar surface, a convex surface, and a concave surface.

12. The convertible carriage of claim 1, wherein the sledge comprises a plurality of runners.

13. The convertible carriage of claim 1, wherein the set of wheel assemblies are configured to be retractable into the receptacle through one or more provisions therefor on the sledge.

14. The convertible carriage of claim 1, comprising a handle attached to the receptacle, wherein the handle is attached to the receptacle through an extendable rod.

15. The convertible carriage of claim 1, comprising a braking means having a braking surface that is operably configured to engage with and impede motion of the set of wheel assemblies.

16. A convertible carriage for transporting subjects on a plurality of operating surfaces, comprising:
a receptacle;
a sledge;
a set of wheel assemblies attached to the receptacle; and
a set of telescopic landing gears attached to the receptacle, and connected to the sledge, wherein the set of telescopic landing gears being configured to operably extend or retract to switch an operation mode of the convertible carriage between a rolling operation mode and a sliding operation mode, wherein in the rolling operation mode, the sledge is retracted to allow one or more wheel assemblies from the set of wheel assemblies to come into contact with the operating surface such that the convertible carriage is transportable on an operating surface by rolling of the one or more wheel assemblies, and wherein in the sliding operation mode, the sledge is in contact with the operating surface such that the convertible carriage is transportable on the operating surface by sliding.

17. The convertible carriage of claim 16, wherein the sledge is configured to a distal end of a corresponding telescopic landing gear from the set of telescopic landing gears such that when the corresponding telescopic landing gear is extended to switch the operation mode of the convertible carriage to the sliding operation mode, the sledge extends to come into contact with the operating surface, and when the corresponding telescopic landing gear is retracted to switch the convertible carriage to the rolling operation mode, the sledge retracts to allow the one or more wheel assemblies to come in contact with the operating surface.

18. The convertible carriage of claim 16, wherein the sledge is connected to the corresponding telescopic landing gear through a set of foldable links such that when the corresponding telescopic landing gear is extended to switch the operation mode the convertible carriage to the rolling operation mode, the sledge is retracted by the set of foldable links and allows the one or more wheel assemblies to come into contact with the operating surface, and when the corresponding telescopic landing gear is retracted to switch the operation mode of the convertible carriage to the sliding operation mode, the sledge is extended by the set of foldable links and comes into contact with the operating surface.

19. A convertible carriage for transporting subjects on a plurality of operating surfaces, comprising:
a receptacle;
a sledge attached to the receptacle; and
a set of wheel assemblies retractably connected to the sledge by an actuation means, the actuation means configured to switch the operation mode of the convertible carriage between a rolling operation mode and a sliding operation mode, wherein in the rolling operation mode, one or more wheel assemblies from the set of wheel assemblies are in contact with an operating surface, and wherein in the sliding operation mode, the one or more wheel assemblies are retracted into the sledge to allow the sledge to come into contact with the operating surface.
